(19) United States
(12) Patent Application Publication
(10) Pub. No.: US 2007/0245939 A1
(43) Pub. Date: Oct. 25, 2007

(54) Method and Seed Boot for Seeding in Wet Soil

(76) Inventor: Ulrich Gehrer, Landmark (CA)

Correspondence Address: ADE & COMPANY INC., 2157 Henderson Highway, WINNIPEG, MB, R2G1P9, US

(21) Appl. No.: 11/670,213

(22) Filed: Feb. 1, 2007

(30) Foreign Application Priority Data
Jan. 2, 2006 (CA) 2535669

(51) Int. Cl. A01C 7/08

(52) U.S. Cl. 111/170

(57) ABSTRACT

A seed boot attaches to a tine of an agricultural heavy harrow so as to be particularly suited for seeding in wet soils. Seeding is accomplished by advancing the harrow across the ground in the forward working direction when the ground is still wet. The tines form furrows within which the seed is deposited. The seed boot comprises a tubular body which is supported directly on the tine and which has a lower portion terminating just above the free end of the tine which is near a width of the tine.

This application claims foreign priority benefits from Canadian Patent Application 2,535,669, filed Feb. 1, 2006.

### FIELD OF THE INVENTION

The present invention relates to a seed boot for attachment to an agricultural harrow, and a method of seeding which is particularly suited for seeding in wet soil using the seed boot supported on the agricultural harrow.

### BACKGROUND

In the field of agriculture, seeding is typically accomplished by an agricultural implement towed by a tractor in which the implement carries a plurality of seed boots extending downwardly and forwardly towards the ground for engaging the ground to form furrows. Typically seed boots are supported rigidly on shanks which have limited deflection so that the seed boots have sufficient strength to break up the ground and form the furrow. A seed delivery mechanism includes a hose associated with each seed boot which delivers seed into the furrow formed by the seed boot. When seeding in wet soils, the orientation of the seed boot projecting downwardly and forwardly into the working direction causes soil to readily collect on the seed boot which affects furrow formation and reduces effectiveness of the seeding operation. The collected soil also greatly increases resistance to the implement being towed across the ground to further reduce effectiveness of furrow formation.

U.S. Pat. No. 5,156,102 to Anderson discloses a seeding operation in which downward and forward projecting tines form furrows within which seed is deposited. Projection of the tines downwardly and into the working direction results in the same problem of wet soil collection on the seeding implement when there is too much moisture in the soil. Furthermore, to maintain the forward projecting angle of the tines, the tines require modification to include a soil penetrating tip mounted thereon rather than the tines themselves forming the furrows.

U.S. Pat. No. 5,769,170 to Skjaeveland and EP013616 to Parsons disclose examples of implements which are configured only for seeding. A series of tines and packer wheels cooperate together to work the ground and subsequently pack the ground over the seeds deposited therein. These implements are not suitable for use as a harrowing implement by themselves but are rather dedicated to use as a seeding implement which is complex and unnecessarily costly for a farmer to maintain.

### SUMMARY OF THE INVENTION

According to one aspect of the invention there is provided a method of seeding comprising;

providing an agricultural harrow comprising a frame supported for movement in a forward working direction across the ground and a plurality of tines supported on the frame;

advancing the harrow across the ground in the forward working direction;

forming a plurality of furrows by supporting the tines to engage the ground as the harrow is advanced in the working direction; and

depositing seed in the furrows formed by the tines.

The use of tines themselves on an agricultural harrow for furrow formation, rather than tine extensions or additional seed boots which form the furrows permit effective formation of furrows for receiving seed in wet soil conditions. The narrow lateral dimension of the tine themselves which form the furrows and their trailing angle on a conventional agricultural heavy harrow prevent accumulation of wet soil thereon so that the tines continue to function effectively at forming a furrow of consistent dimension suitable for receiving seed deposited therein. Use of the tines on an existing heavy harrow not only produces effective furrows for seeding in wet soil, but also permits a farmer to use as mush existing equipment as possible so that very little additional investment is required to permit the additional seeding operation in wet soil conditions.

When it is desirable to seed in wet soil conditions, the method preferably includes advancing the harrow across the ground in the forward working direction when the ground is still wet.

Working the ground is preferably accomplished only with the tines as the harrow is advanced in the forward working direction.

The harrow preferably comprises an existing commercially available agricultural heavy harrow having a drawbar supported on wheels and frame sections on the drawbar which support the tines thereon and tines which are greater than ½ inch in diameter. The tines are typically straight and individually sprung in relation to the frame.

The method preferably includes modifying the existing commercially available agricultural harrow to include a seed delivery mechanism. In this instance, a separate seed cart may be advanced in series with the agricultural harrow for delivering seed to individual seed boots in association with the tines respectively via seed delivery hoses.

In use, the tines are preferably supported to trail downwardly and rearwardly from the frame as the harrow is advanced in the forward working direction for forming the furrows with an existing and unmodified portion of the tines.

Seed may be deposited in the furrows formed only by foremost ones of the tines or in the furrows formed only by rearmost ones of the tines dependent upon desired furrow formation and seed covering.

Preferably the seed boots are supported directly on the tines respectively for movement therewith such that the respective tine upon which each seed boot is supported projects downwardly beyond the bottom end of the seed boot.

Each seed boot may be supported for sliding movement relative to the respective tine upon which the seed boot is supported and preferably includes clamping means for clamping the seed boots on the respective tines using threaded fasteners.

Each seed boot preferably comprises an elongate delivery tube oriented parallel to the respective tine upon which the seed boot is supported and having a lateral dimension transverse to the forward working direction at the lower end which is near a diameter of the tines.

According to a second aspect of the present invention there is provided a seed boot arranged for being supported on an agricultural harrow comprising a frame supported for movement in a forward working direction across the ground and a plurality of tines supported on the frame and arranged for engaging the ground, the seed boot comprising;

a tubular body having an upper end arranged for connection to a seed delivery hose and a lower end arranged for depositing seed therefrom: and

a mounting mechanism arranged for supporting the tubular body in alignment with a respective one of the tines of the harrow.

The mounting means are preferably arranged to support the tubular body directly on the respective tine such that the tine projects downwardly beyond the bottom end of the seed boot, parallel to the tubular body.

When the mounting means comprise a sleeve supported on a leading side of the tubular body for slidably receiving the respective tine therethrough, the sleeve being preferably oriented parallel to the tubular body and preferably locating a clamping member thereon for clamping the tine within the sleeve.

The tubular body is preferably round in cross section at the upper end for receiving the seed delivery hose therein and has a lateral dimension at the lower end which is narrower in relation to the upper end so as to be near a diameter of the tines.

A discharge opening at the lower end of the tubular body is preferably sloped upwardly and rearwardly from a leading side to a trailing side of the tubular body.

Embodiments of the invention will now be described in conjunction with the accompanying drawings in which:

### BRIEF DESCRIPTION OF THE DRAWINGS

FIG. 1 is a side elevational schematic view of the seed boot in use for seeding in wet soil.

FIG. 2 is a side elevational view of a heavy harrow.

FIG. 3 is a rear elevational view of a plurality of seed boots supported on respective tines of the harrow.

FIG. 4 is a side elevational view of one of the tines showing the seed boot supported thereon.

FIG. 5 is a sectional view along the line 5-5 of FIG. 4.

FIG. 6 is a perspective view of one section of the heavy harrow in which the seed boots are shown in a foremost mounted position in accordance with FIGS. 1 and 2 in dashed line, and in a rearmost mounted position in solid line.

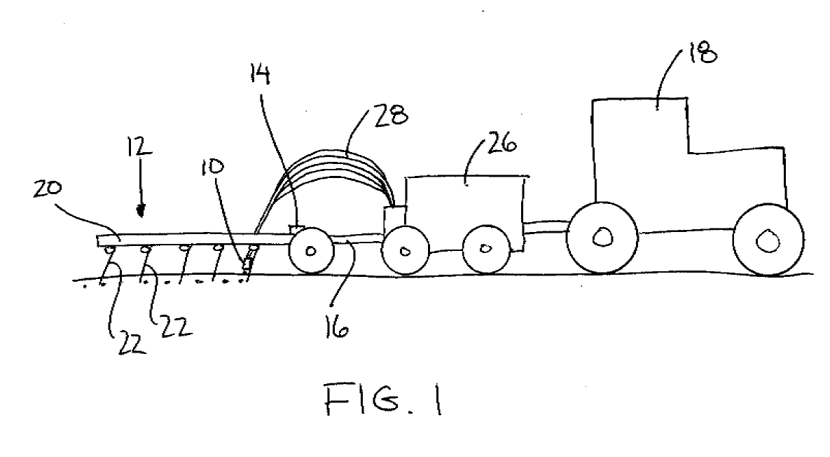

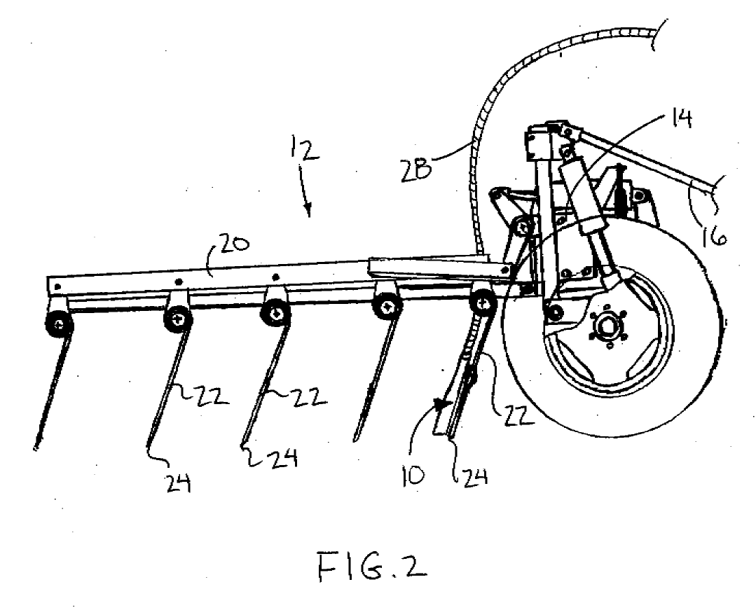

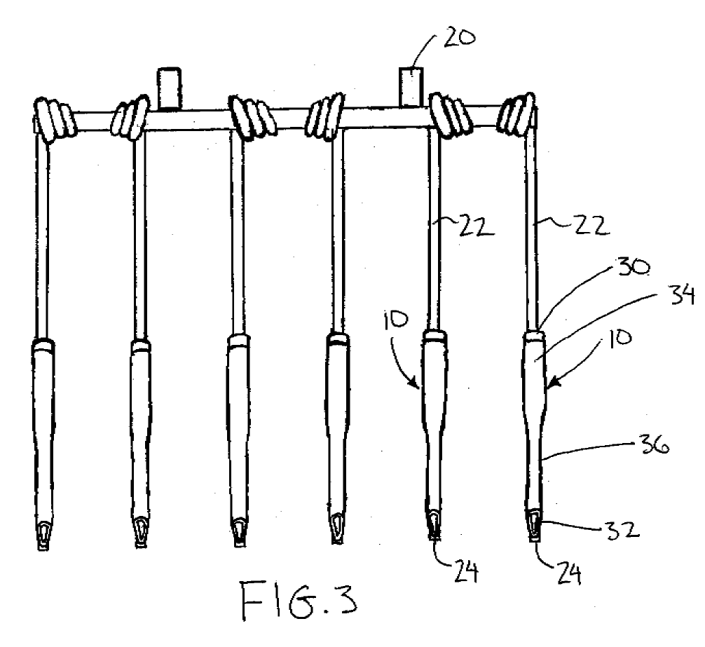

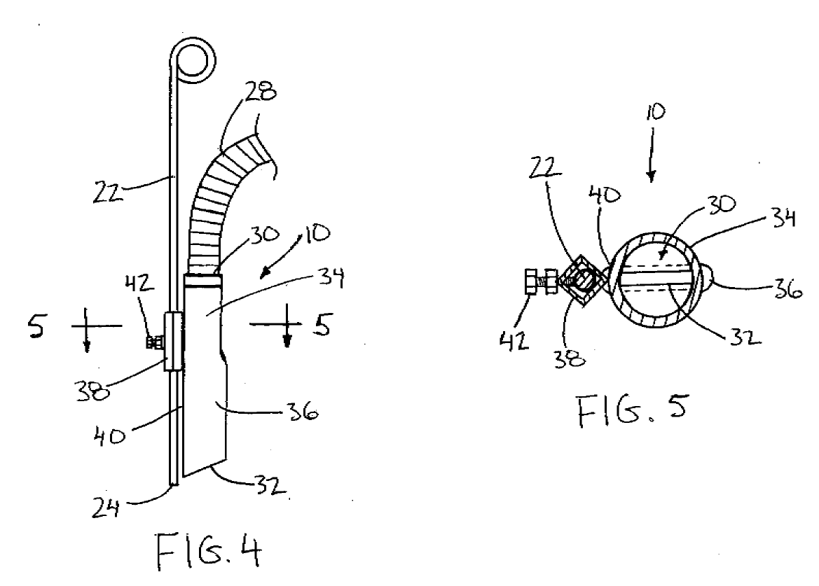

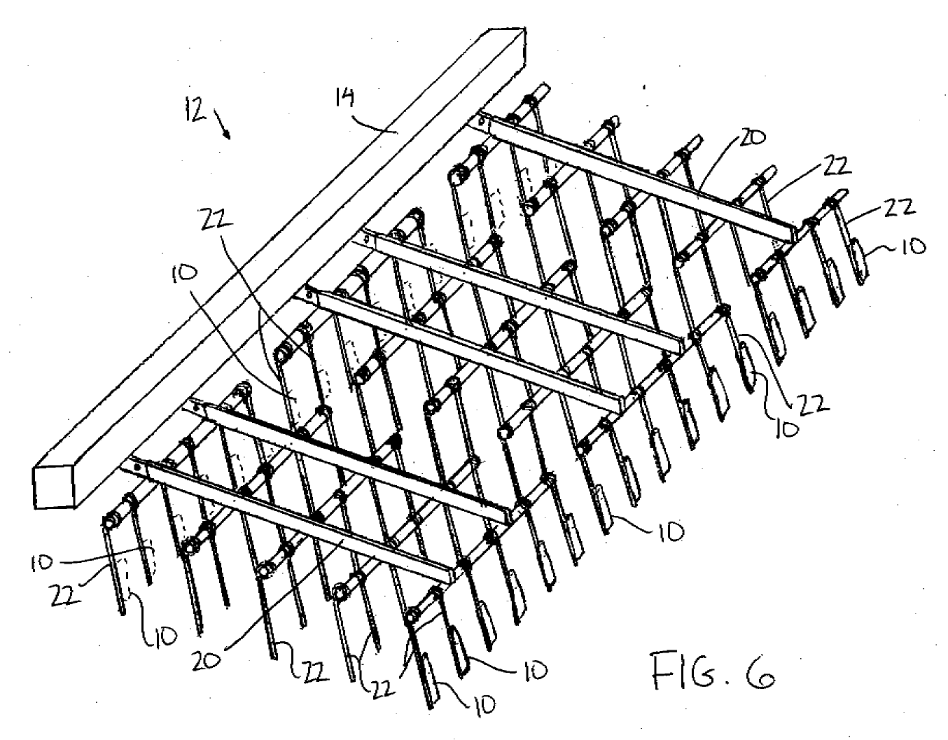

In the drawings like characters of reference indicate corresponding parts in the different figures.

### DETAILED DESCRIPTION

Referring the accompanying figures there is illustrated a seed boot generally indicated by reference numeral 10. The boot 10 is particularly suited for being supported on an agricultural harrow 12 for seeding in wet soil conditions.

The harrow 12 generally comprise an existing commercially available heavy harrow having a drawbar 14 supported on wheels for movement across the ground in a forward working direction. A hitch 16 permits connection to a towing vehicle, for example an agricultural tractor 18. A plurality of frame sections 20 are coupled to the drawbar 14 so as to be adjustable in height by conventional hydraulics in relation to the wheels. A plurality of tines 22 are supported on each frame section which are adjustable in angle relative to the frame sections. Depth of penetration of the tines 22 into the ground as the harrow is advanced in the forward working direction is adjustable by adjusting the height of the frame sections relative to the wheels and by adjusting the tine angle.

Each tine 22 comprises a straight rod having a diameter of approximately ⅝ of an inch and a length of nearly 2 feet extending from a top end which is individually sprung on the frame section 20 to a bottom free end 24 which engages the ground. Furrows are formed by the free ends 24 of the tines engaging the ground as the harrow is towed by the tractor 18 in the forward working direction.

The seed boots 10 are individually supported on the tines 22 respectively on one or more rows spanning the full width of the harrow. The seed boots may be supported on only foremost or on only rearmost rows of the tines as may be desired to affect furrow formation and subsequent seed covering.

A seed delivery mechanism is provided in the form of a separate seed cart 26 which is towed in series with the tractor and the harrow for carrying seed. The seed cart 26 is conventional in nature and includes a seed delivering mechanism including a blower, seed meters and a manifold of air hoses 28 which are connected to the seed boots 10 respectively.

Each seed boot 10 comprises a tubular body which is straight in a longitudinal direction between a top end 30 and a bottom end 32. The top and bottom ends are open for receiving the seed therethrough.

The tubular body includes an upper portion 34 which is round in cross section and has an internal diameter which is approximately equal to the outer diameter of the seed hose 28 for fitting the hose therein. The hose may be held in place by a suitable clamp or a snug fit relationship.

A lower portion 36 of the tubular body is narrow in a lateral dimension perpendicular to the forward working direction in relation to the upper portion 34. The lower portion 36 is defined by two flat sides which are spaced near a diameter of the tines in the lateral direction so as to minimize the additional resistance to the tines forming furrows in the ground.

The upper and lower portions are joined by a smooth and sloped transition to permit seed to be readily deposited therethrough from the open top end 30 to the open bottom end 32.

The open bottom end 32 defines a discharge opening lying in a plane which is sloped upwardly and rearwardly from a leading side to a trailing side of the tubular body.

A mounting sleeve 38 is mounted along the leading side of the tubular body so as to be generally parallel to the longitudinal direction of the body. The sleeve 38 is centered with respect to the tubular body so as that the sleeve and lower portion are aligned with one another in the forward working direction. The lower portion 36 of the tubular body is thus directly behind the respective tine upon which the mounting sleeve 38 is mounted.

The mounting sleeve in the illustrated embodiment has a square cross section, however any shape which permits the round cross section of the tine to be slidably received therein is effective. The internal diameter of the mounting sleeve is near one inch to permit tines having a diameter of ½ or greater to be readily received therein. The mounting sleeve 38 is welded to the tubular body so as to be fixed in relative orientation.

A threaded aperture is formed in the leading side of the sleeve 38 opposite the tubular body for threadably receiving a clamping bolt 42 therein. The position of the tubular body can thus be adjusted relative to the tine by sliding the mounting sleeve 38 in the longitudinal direction of the tine until a desired height is set at which point the clamping bolt 42 frictionally engages the tine to fix the seed boot in place directly on the tine for movement therewith.

The seed boot is positioned such that the free end of the tine projects downwardly beyond the bottom end of the tubular body with the tine and longitudinal direction of the tubular body being parallel to one another. The seed boot is thus supported at the trailing side of the tine above the bottom free end of the tine, to be moveable with the tine relative to the frame as the tines are flexed. The lower portion 36 of the seed boot being near the width of the tine permits only a portion of the existing tine to form the furrow with little resistance to ground penetration when the tines are trailing downwardly and rearwardly in engagement with wet soils.

In use, an existing heavy harrow is modified to include a plurality of seed boots supported directly on the tines of one or more rows of the harrow tines. The seed boots are secured only by the threaded clamping bolts 42 so as not to effect the material properties of the tine due to excessive heat from welding for example, while permitting the seed boots to be readily removable for subsequent conventional use of the heavy harrow a desired.

When towed across the ground in the forward working direction, the harrow is advanced in series with a tractor and a seed cart therebetween which includes a conventional seed delivery mechanism having seed delivery hoses connected to the seed boots on the heavy harrow respectively. The round upper portion of the seed boots snugly receive the respective hoses therein to be subsequently fixed in place. The flexible hoses do not affect movement of the tines relative to the harrow frame.

During a seeding operation, the heavy harrow is adjusted so that most of the weight of the harrow frame is carried by the tines rather than on the wheels of the harrow frame to ensure adequate penetration of the tines into the ground for optimum seed depth. The furrows formed by the harrow are formed by an existing portion of the tines only which work the ground and no additional disc units or packer wheels are required for furrow formation or subsequent seed covering. The furrow depth can also be adjusted by setting the tine angle which is generally sloping rearwardly at a downward incline in use. The tine angle is typically adjusted dependent upon soil moisture to control seed depth.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of seeding comprising;
providing an agricultural harrow comprising a frame supported for movement in a forward working direction across the ground and a plurality of tines supported on the frame;
advancing the harrow across the ground in the forward working direction;
forming a plurality of furrows by supporting the tines to engage the ground as the harrow is advanced in the working direction; and
depositing seed in the furrows formed by the tines.

2. The method according to claim 1 including advancing the harrow across the ground in the forward working direction when the ground is wet.

3. The method according to claim 1 including working the ground only with the tines as the harrow is advanced in the forward working direction.

4. The method according to claim 1 including providing a heavy harrow having a drawbar supported on wheels and frame sections on the drawbar which support the tines thereon and tines which are greater than ½ inch in diameter.

5. The method according to claim 1 including providing an agricultural harrow having straight tines which are individually sprung in relation to the frame.

6. The method according to claim 1 including providing an existing commercially available agricultural harrow and depositing seed in the furrows by modifying the existing commercially available agricultural harrow to include a seed delivery mechanism.

7. The method according to claim 1 including depositing seed in the furrows by providing a separate seed cart advanced in series with the agricultural harrow and providing individual seed boots in association with the tines respectively which receive seed from the seed cart via seed delivery hoses.

8. The method according to claim 1 including forming the plurality of furrows by supporting the tines to trail downwardly and rearwardly from the frame as the harrow is advanced in the forward working direction.

9. The method according to claim 1 including depositing seed in the furrows formed only by foremost ones of the tines.

10. The method according to claim 1 including depositing seed in the furrows formed only by rearmost ones of the tines.

11. The method according to claim 1 including engaging the ground and forming the furrows with an existing portion of the tines of the harrow.

12. The method according to claim 1 including depositing seed through seed boots and supporting the seed boots on the tines respectively for movement therewith.

13. The method according to claim 12 including orienting each seed boot such that the respective tine upon which the seed boot is supported projects downwardly beyond the bottom end of the seed boot.

14. The method according to claim 12 including supporting each seed boot for sliding movement relative to the respective tine upon which the seed boot is supported.

15. The method according to claim 12 wherein each seed boot comprises an elongate delivery tube and wherein the method includes orienting each seed boot parallel to the respective tine upon which the seed boot is supported.

16. The method according to claim 12 including clamping the seed boots onto the respective tines with threaded fasteners.

17. The method according to claim 12 including forming the seed boots to have a lateral dimension transverse to the forward working direction which is near a diameter of the tines.

18. The method according to claim 12 including forming a discharge opening at a bottom end of each seed boot to extend upwardly and rearwardly as the harrow is advanced in the forward working direction.

19. A seed boot arranged for being supported on an agricultural harrow comprising a frame supported for movement in a forward working direction across the ground and a plurality of tines supported on the frame and arranged for engaging the ground, the seed boot comprising;
a tubular body having an upper end arranged for connection to a seed delivery hose and a lower end arranged for depositing seed therefrom; and
a mounting mechanism arranged for supporting the tubular body in alignment with a respective one of the tines of the harrow.

20. The seed boot according to claim 19 wherein the mounting means are arranged to support the tubular body directly on the respective tine.
